(19) United States
(12) Patent Application Publication
(10) Pub. No.: US 2025/0348919 A1
(43) Pub. Date: Nov. 13, 2025

(54) INFORMATION SEARCH SUPPORT SYSTEM, INFORMATION SEARCH SUPPORT METHOD AND INFORMATION DISPLAY SYSTEM

(71) Applicant: Hitachi, Ltd., Tokyo (JP)

(72) Inventors: Hideki SHIMOBAYASHI, Tokyo (JP); Kenji FUJIHIRA, Tokyo (JP)

(21) Appl. No.: 19/071,071

(22) Filed: Mar. 5, 2025

(30) Foreign Application Priority Data
May 9, 2024 (JP) 2024-076322

(51) Int. Cl. G06Q 30/0601; G06F 3/01

(52) U.S. Cl. CPC G06Q 30/0631; G06F 3/013; G06F 2203/011

(57) ABSTRACT

Information search support system which estimates in real time a user interest level which indicates a level of interest of the user in each piece of recommended information based on user information acquired over a predetermined time period, estimates in real time a level of attention which indicates a level to which the user is currently paying attention to each piece of recommended: information based on currently acquired user information, calculates a level of suitability for each piece of recommended information based on the interest level and the attention level, acquires new recommended information from the information recommendation system based on the user information and the interest level, and determines a timing of switching to suitable recommended information based on the suitability level, the interest level, and the new recommended information, and requests the information display terminal to switch the recommended information being displayed.

### CROSS-REFERENCE TO PRIOR APPLICATION

This application relates to and claims the benefit of priority from Japanese Patent Application number 2024-076322, filed on May 9, 2024 the entire disclosure of which is incorporated herein by reference.

### BACKGROUND OF THE INVENTION

### 1. Field of the Invention

The present invention can be suitably applied to an information search support system, an information search support method, and an information display system related to, for example, a technique for optimally searching for recommended information ideal for a user by using the user's behavior information.

### 2. Description of the Related Art

In recent years, the number of visitors to commercial facilities with physical stores has decreased due to the popularization of so-called e-commerce after the COVID-19 pandemic. Commercial facility operators and tenant operators are promoting the use of digital technologies such as digital signage and metaverse stores in order to improve the user experience in physical stores and acquire new revenue sources such as retail media advertising. These digital technologies allow users to deepen their understanding of tenants and products. Meanwhile, for example, in physical stores, the effort required to find the product which is suitable for the user from the vast product lineup in the store is still high, and attempts are being made to innovate the user experience by using information recommendation technology.

Many e-commerce sites have introduced product recommendation systems which utilize the user's operation history, browsing history, and purchase history to recommend information in response to user operations. PTL 1 discloses a product recommendation system which recommends products to users based on the user's operation history, such as purchasing, browsing, and adding products to an electronic shopping cart. This allows information tailored to the user's hobbies and preferences to be displayed in response to user operations. The technology disclosed in PTL 1 can estimate the user's interests in real time based on the user's operation history and other information, and recommend information suitable for the user. This is expected to reduce the effort required to find recommended product information suitable for the user from a huge number of products in a store.

### Patent Literature

[PTL 1] U.S. Pat. No. 7,113,917

### SUMMARY OF THE INVENTION

### Problems to be Solved by the Invention

Nevertheless, with the technology described in PTL 1, information is switched when an explicit user operation (such as a touch, scroll, or move) is performed, and it is not possible to switch the displayed recommended information in real time without a user operation.

The present invention was devised in consideration of the problem described above, and its object is to propose an information search support system, an information search support method, and an information display system which can switch to and display recommended information which is more likely to attract the user's interest without compromising user convenience.

### Means to Solve the Problems

In order to achieve the foregoing object, the present invention provides an information search support system which coordinates with an information recommendation system which provides recommended information to an information display terminal which displays the recommended information to a user, comprising: a user information acquisition unit which acquires user information including line of sight information indicating a line of sight of the user toward the information display terminal; a user interest level calculation unit which estimates in real time a user interest level which indicates a level of interest of the user in each piece of recommended information based on user information acquired over a predetermined time period; a user attention level calculation unit which estimates in real time a level of attention which indicates a level to which the user is currently paying attention to each piece of recommended information based on currently acquired user information; a recommendation suitability level calculation unit which calculates a level of suitability for each piece of recommended information based on the interest level and the attention level; a recommended information acquisition unit which acquires new recommended information from the information recommendation system based on the user information and the interest level; and a display information control unit which determines a timing of switching to suitable recommended information based on the suitability level, the interest level, and the new recommended information, and requests the information display terminal to switch the recommended information being displayed.

The present invention further provides an information search support method based on an information search support system which coordinates with an information recommendation system which provides recommended information to an information display terminal which displays the recommended information to a user, comprising: a user information acquisition step of a user information acquisition unit acquiring user information including line of sight information indicating a line of sight of the user toward the information display terminal; a user interest level calculation step of a user interest level calculation unit estimating in real time a user interest level which indicates a level of interest of the user in each piece of recommended information based on user information acquired over a predetermined time period; a user attention level calculation step of a user attention level calculation unit estimating in real time a level of attention which indicates a level to which the user is currently paying attention to each piece of recommended information based on currently acquired user information; a recommendation suitability level calculation step of a recommendation suitability level calculation unit calculating a level of suitability for each piece of recommended information based on the interest level and the attention level; a recommended information acquisition step of a recommended information acquisition unit acquiring new recommended information from the information recommendation system based on the user information and the interest level; and a display information control step of a display information control unit determining a timing of switching to suitable recommended information based on the suitability level, the interest level, and the new recommended information, and requesting the information display terminal to switch the recommended information being displayed.

The present invention additionally provides an information display system based on an information search support system which coordinates with an information recommendation system which provides recommended information to an information display terminal which displays the recommended information to a user, comprising: a user information acquisition unit which acquires user information including line of sight information indicating a line of sight of the user toward the information display terminal; a user interest level calculation unit which estimates in real time a user interest level which indicates a level of interest of the user in each piece of recommended information based on user information acquired over a predetermined time period; a user attention level calculation unit which estimates in real time a level of attention which indicates a level to which the user is currently paying attention to each piece of recommended information based on currently acquired user information; a recommendation suitability level calculation unit which calculates a level of suitability for each piece of recommended information based on the interest level and the attention level; a recommended information acquisition unit which acquires new recommended information from the information recommendation system based on the user information and the interest level; a display information control unit which determines a timing of switching to suitable recommended information based on the suitability level, the interest level, and the new recommended information, requests the information display terminal to switch the recommended information being displayed; and an information display terminal which displays the recommended information.

### Advantageous Effects of the Invention

According to the present invention, it is possible to switch to and display recommended information which is likely to attract the user's interest without compromising user convenience.

### BRIEF DESCRIPTION OF DRAWINGS

FIG. 1 is a diagram showing the schematic configuration of an overall information display system of this embodiment;

FIG. 2 is a diagram showing the configuration of a user information control server;

FIG. 3 is a diagram showing the configuration of a recommended information control server;

FIG. 4 is a sequence diagram explaining the operation of an information search and display system;

FIG. 5 is a flowchart detailing the processing performed by a user interest level calculation unit of the user information control server in step S212 of FIG. 4;

FIG. 6 is a flowchart detailing the processing performed by a user attention level calculation unit of the user information control server in step S213 of FIG. 4;

FIG. 7 is a flowchart detailing the processing performed by a recommendation suitability level calculation unit of the user information control server in step S216 of FIG. 4;

FIG. 8A is a flowchart detailing the processing performed by a display information control unit of the recommended information control server in step S218 and step S220 of FIG. 4 in the first embodiment;

FIG. 8B is a flowchart detailing the processing performed by a display information control unit of the recommended information control server in step S218 and step S220 of FIG. 4 in the first embodiment;

FIG. 9 is a diagram showing the details of the display information data;

FIG. 10A is a diagram showing a case where recommended information is displayed on the information display terminal in step S222 of FIG. 4;

FIG. 10B is a diagram showing an example of the suitability level calculated based on the interest level and the attention level for each display ID corresponding to the example shown in FIG. 10A;

FIG. 11A is a diagram showing a case where recommended information is displayed on the information display terminal in step S222 of FIG. 4;

FIG. 11B is a diagram showing an example of the suitability level calculated based on the interest level and the attention level for each display ID corresponding to the example shown in FIG. 11A;

FIG. 12A is a flowchart detailing the processing performed by a display information control unit of the recommended information control server in step S218 and step S220 of FIG. 4 in the second embodiment; and

FIG. 12B is a flowchart detailing the processing performed by a display information control unit of the recommended information control server in step S218 and step S220 of FIG. 4 in the second embodiment.

### DESCRIPTION OF THE PREFERRED EMBODIMENTS

An embodiment of the present invention is now explained in detail with reference to the appended drawings.

### (1) First Embodiment

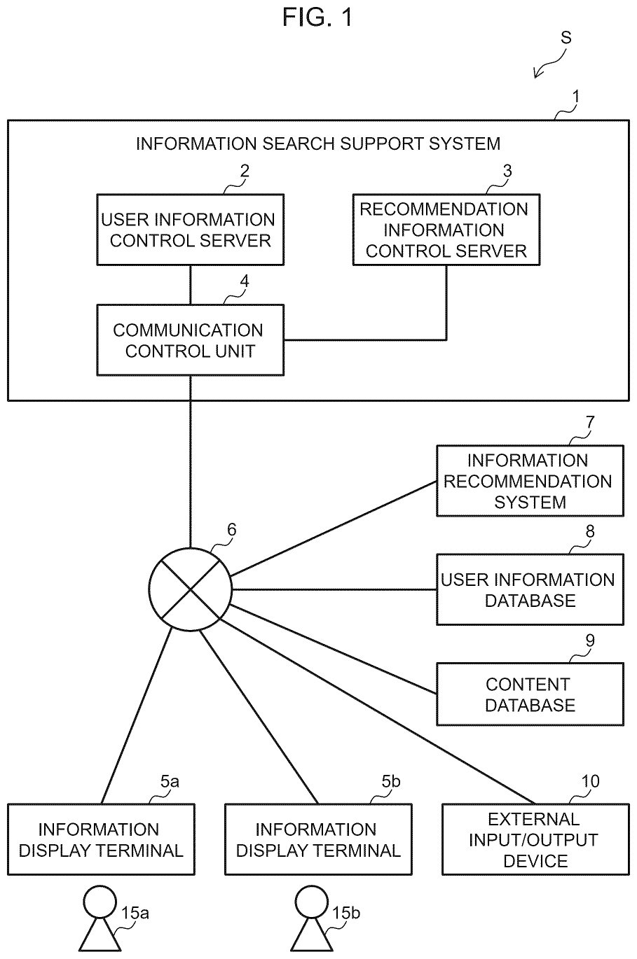

FIG. 1 is a diagram showing the schematic configuration of an overall information display system S including an information search support system 1 of the first embodiment.

As shown in FIG. 1, the information display system S includes at least an information search support system 1 which controls information display based on user information, and information display terminals 5a and 5b which display recommendation results selected by the information search support system 1, and preferably further includes an information recommendation system 7 which provides recommended information to the information search support system 1, a user information database 8 which stores information related to users, a content database 9 which stores contents to be provided to users, and an external input/output device 10 which acquires information related to users. Note that, when there is no need to particularly differentiate between the information display terminal 5a as a fixed-type signage device and the information display terminal 5b as a user-wearable virtual space display device, they will be collectively referred to as the “information display terminals 5”.

The information search support system 1, the information display terminals 5a and 5b, the information recommendation system 7, the user information database 8, and the external input/output device 10 are connected via a network 6. Note that the recommended information may be stored in the information search support system 1 rather than being provided by the information recommendation system 7.

The information search support system 1 coordinates with the information recommendation system 7 which provides recommended information to the information display terminal 5 which displays the recommended information to a user. The information search support system 1 comprises a user information control server 2, a recommended information control server 3, and a communication control unit 4. The user information control server 2 acquires information related to the user's attributes and behavior, and performs various computations related to the estimation of the user's condition, such as the user's interest level, attention level, and suitability level.

The recommended information control server 3 acquires recommended information, and various computations related to the content of the display information to be switched based on the user's condition and the timing of switching the recommended information. The communication control unit 4 sends and receives information to and from the information display terminals 5a and 5b, the information recommendation system 7, the user information database 8, the content database 9, and the external input/output device 10 via the network 6.

The information display terminals 5a and 5b are each a terminal device which displays a list of recommended information, for example, to a user 15a as a facility visitor and a user 15b as a remote visitor. In the illustrated example, while two information display terminals 5a and 5b are displayed, the number of information display terminals is not limited to two and may be any number.

The information display terminal 5 is a device which is installed at a predetermined position inside or outside a facility, and provides recommended information. Specifically, for example, the information display terminal 5 is a general-purpose personal computer (PC), mobile computer, smartphone, tablet, or computer device equipped with a display device such as VR (Virtual Reality) goggles. Here, the fixed-type signage device is designated as 5a, and the wearable virtual space display device is designated as 5b.

The information recommendation system 7 selects information to be recommended to the user based on the user information data acquired by the information search support system 1. Here, the recommended information may include a recommendation level, information category, content correspond to the recommended information, and relationship with other recommended information.

The user information database 8 stores user information related to the user such as the user's attributes, preferences, purchase history, and browsing history. Here, the user information may also be acquired based on a user ID which identifies the user.

The content database 9 stores content display data as data of the content to be displayed in the recommended information. Here, the content display data is data including at least one of text data, image data, video data, voice data, and three-dimensional model data.

The external input/output device 10 is not particularly limited so as long it is a device which acquires information of a user viewing the display information terminal, or presents information to a user viewing the information display terminal. The external input/output device 10 is, for example, a device which provides information to a user by voice in the first embodiment described later. The external input/output device 10 is, for example, a device which measures the user's heart rate in the first embodiment described later. The external input/output device 10 may be a computer device such as a PC or a mobile computer.

The information search support system 1, the information display terminal 5, and the external input/output device 10 each include, for example, a processor such as a CPU (Central Processing Unit) which controls each unit through the execution of programs, and a display device such as a display which displays images and other information. Moreover, the information search support system 1, the information display terminal 5, and the external input/output device 10 each include, for example, an input/output device such as a touch display for inputting the user's touch operation or flick operation.

In addition, the information search support system 1, the information display terminal 5, and the external input/output device 10 each include, for example, a communication interface used for communicating with external devices (hereinafter referred to as the “communication I/F”), and a memory such as a RAM (Random Access Memory) or storage which stores system data and internal data.

The network 6 is a communication means used for information communication among the information search support system 1, the information display terminal 5, the information recommendation system 7, the user information database 8, the content database 9, and the external input/output device 10, and is, for example, the Internet, a LAN (Local Area Network), or a WAN (Wide Area Network). The communication lines used for information communication may be wired or wireless, and may be a combination of both. In addition, a gateway device, a router, or other relay device may be used to connect via multiple networks or communication lines.

The information search support system 1 is foremost explained. In this embodiment, the user is near the information display terminal 5a, which is, for example, a fixed-type signage device installed within a commercial facility or a store. When the user stands in front of the information display terminal 5a, the information display terminal 5a displays recommendation information based on the user's attributes and behavior information so as to be arranged in its display area. Here, the information search support system 1 and the information display terminal 5 selects recommended information in which the user has no interest based on the user's line of sight information, and switches the selected recommended information at a timing when the user's line of sight is not facing the selected recommended information.

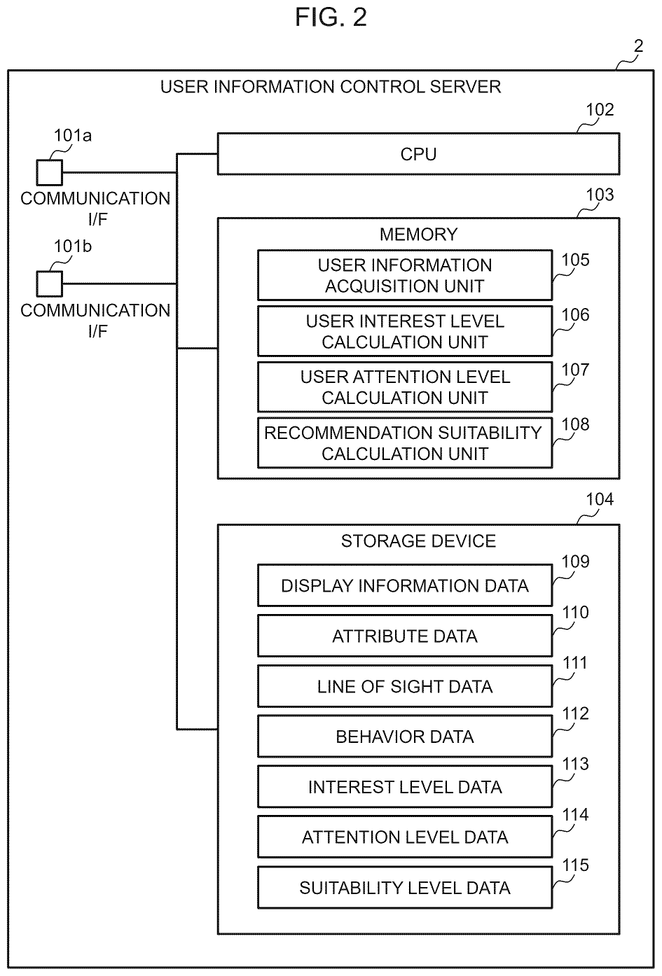

FIG. 2 is a diagram showing the configuration of the user information control server 2. As shown in FIG. 2, the user information control server 2 includes communication I/Fs 101a and 101b, a CPU 102, a memory 103, and a storage device 104. The communication I/Fs 101a and 101b exchange information with the recommended information control server 3 and the communication control unit 4.

The CPU 102 performs computations to execute the processing performed by the user information control server 2. The CPU 102 functions as a display information data acquisition unit which acquires display information data 109 regarding the recommended information currently being displayed on the information display terminal

The memory 103 stores programs for realizing the functions of a user information acquisition unit 105, a user interest level calculation unit 106, a user attention level calculation unit 107, and recommendation suitability level calculation unit 108, and the CPU 102 executes these programs.

The user information acquisition unit 105 acquires user information including line of sight information indicating a line of sight of a user toward a display area of the information display terminal 5. The user information acquisition unit 105 acquires, as the user information, the user's behavior information and the user's attribute information in addition to the line of sight information.

The line of sight information described above is acquired by at least one of an eye tracking device built into the information display terminal 5 and a device installed in the external environment, and projected as a line of sight center point onto a line of sight detection surface taking the form of at least one of a two-dimensional surface and a three-dimensional shape.

The behavior information described above includes at least one of the user's posture information, operation information, heart rate, facial expression and voice information, and is acquired by at least one of the information display terminals 5a and 5b, a device installed in the external environment, and a device worn by the user.

The attribute information described above includes at least one of the user's age, gender, preference information, online purchase history, and browsing history, and is obtained from at least one of a device held by the user or an external server device in which the user's attribute information is registered.

The user information acquisition unit 105, which will be described in detail later, acquires user information from the information display terminal 5 and calculates attribute data 110 related to the user's attributes, line of sight data 111 related to the user's line of sight, and behavior data 112 related to the user's behavior. In addition, a part of the user information may be acquired from the user information database 8 connected via the network 6.

The user interest level calculation unit 106, which will be described in detail later, calculates interest level data 113, which is information on the level of interest of the user in each piece of recommended information, based on user information over a certain period of time. In other words, the user interest level calculation unit 106 estimates the interest level, which indicates the level of interest of the user in each piece of recommended information, for example in real time, based on user information acquired over a certain period of time.

The user interest level calculation unit 106 uses the line of sight information to, for example, add a value to each piece of recommended information when the line of sight center point is included within the display area of the recommended information, and regards the cumulative value over a certain period of time as the interest level for each piece of recommended information.

The user interest level calculation unit 106 uses the line of sight information to subtract the interest level in each piece of recommended information when, for example, the line of sight center point is not included in the display area of the recommended information.

The user interest level calculation unit 106 adjusts the size of the addition value and the subtraction value using the line of sight information, the behavior information, and the attention level, and changes them as necessary.

The user attention level calculation unit 107, which will be described in detail later, calculates attention level data 114, which is information on the level to which the user is currently paying attention to each piece of recommended information at a certain point in time, based on user information at a certain point in time. In other words, the user attention level calculation unit 107 estimates, for example, in real time, the attention level which indicates the level to which the user is currently paying attention to each piece of recommended information, based on currently acquired user information.

The user attention level calculation unit 107 determines a value calculated based on the distance between the current line of sight center point obtained by using the line of sight information and the display area of the recommended information as the attention level for each piece of recommended information.

The recommendation suitability level calculation unit 108, which will be described in detail later, calculates suitability level data 115, which is information on the level to which a user would feel that displaying certain recommended information to the user is favorable. In other words, the recommendation suitability level calculation unit 108 calculates the suitability level of each piece of recommended information based on the interest level and the attention level.

The storage device 104 stores data used by the programs executed by the CPU 102. The storage device 104 stores various data, such as display information data 109, attribute data 110, line of sight data 111, behavior data 112, interest level data 113, attention level data 114, and suitability level data 115.

The display information data 109, which will be described in detail later, is information related to the recommended information being displayed on the information display terminal 5 obtained from the recommended information control server 3, and includes the position and size of the information display area, as well as the content of the recommended information.

The attribute data 110, which will be described in detail later, includes information regarding the user's attributes, such as the user's age, gender, preference information, advertising history, purchase history, and browsing history, obtained from the information display terminal 5, the user information database 8, and the external input/output device 10.

The line of sight data 111, which will be described in detail later, includes information related to the user's line of sight acquired from the information display terminal 5 and the external input/output device 10.

The behavior data 112, which will be described in detail later, includes information related to the user's behavior acquired from the information display terminal 5 and the external input/output device 10.

As described above, the interest level data 113 is information on the level of interest of the user in each piece of recommended information being displayed, which is calculated by the user interest level calculation unit 106. The interest level data 113 corresponding to each piece of recommended information may be a single piece of data, or may be handled as data having multiple areas.

As described above, the attention level data 114 is information on the level to which the user is paying attention to each piece of recommended information being displayed at a certain point in time. The attention level data 114 corresponding to each piece of recommended information may be a single piece of data or may be handled as data having multiple areas.

As described above, the suitability level data 115 is information on the level to which the user feels it is favorable to receive information recommendation for each piece of recommended information being displayed. In addition, the suitability level data 115 corresponding to each piece of recommended information may be a single piece of data or may be handled as data having multiple areas.

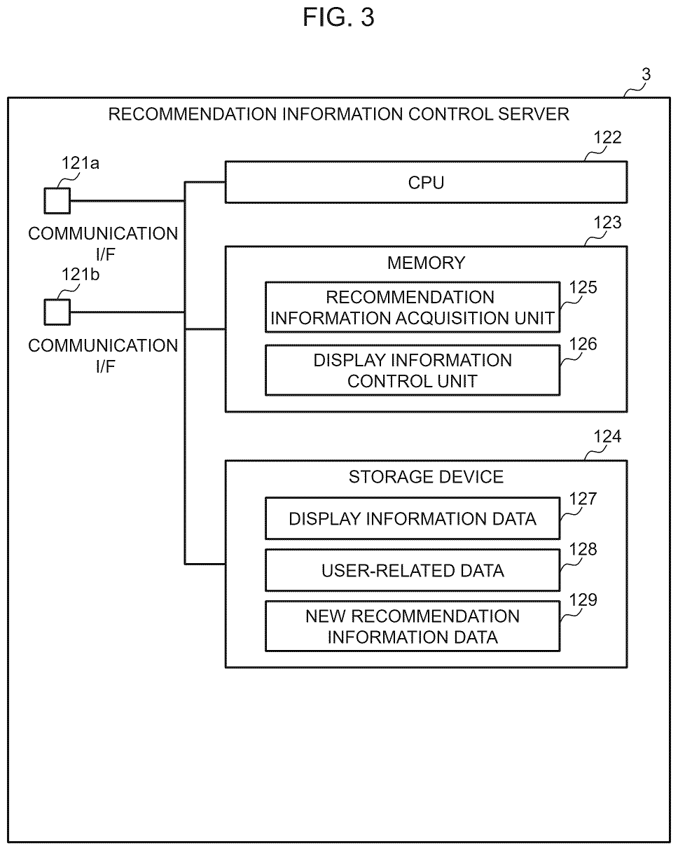

FIG. 3 is a diagram showing the configuration of the recommended information control server 3. As shown in FIG. 3, the recommended information control server 3 includes communication I/Fs 121a and 121b, a CPU 122, a memory 123, and a storage device 124. The communication I/Fs 121a and 121b exchange information with the user information control server 2 and the communication control unit 4.

The CPU 122 performs computations to execute the processing performed by the recommended information control server 3. The CPU 122 functions as a display information data acquisition unit which acquires display information data 127 regarding the recommended information currently displayed on the information display terminal from the user information control server 2 as display information data 109. Furthermore, the CPU 122 functions as a content data acquisition unit which acquires content data related to the recommended information acquired by the recommended information acquisition unit 125 from the content database 9 via the network 6.

The memory 123 stores programs to execute the functions of the recommended information acquisition unit 125 and the display information control unit 126, and the CPU 122 executes these programs.

The recommended information acquisition unit 125, which will be described in detail later, requests recommended information from the information recommendation system 7 connected via the network 6 based on user-related data 128 including the user's attribute information and behavior information acquired from the user information control server 2, acquires the recommended information from the information recommendation system 7, and calculates it as new recommended information data 129. In other words, the recommended information acquisition unit 125 acquires new recommended information from the information recommendation system 7 based on the user information and the interest level.

The display information control unit 126 determines the timing of switching to suitable recommended information based on the suitability level, the interest level, and the new recommended information, and requests the information display terminal 5 to switch the recommended information being displayed.

The display information control unit 126 selects the recommended information with a high level of interest as suitable information, calculates an information similarity between the suitable information and the recommended information whose suitability level is equal to or lower than a threshold, and switches the display of the recommended information whose information similarity is equal to or lower than the threshold to the display of new recommended information selected based on the suitable information from a new recommended information group acquired from the recommended information acquisition unit 125 at a point in time when the attention level becomes equal to or less than the threshold.

The display information control unit 126 selects the recommended information whose suitability is equal to or greater than a threshold as suitable information, calculates an information similarity between the suitable information and new recommended information acquired from the recommended information acquisition unit 125, and switches the display of the suitable information to a display of new recommended information selected based on the suitable information from the new recommended information group acquired from the recommended information acquisition unit 125 at a point in time when the attention level becomes equal to or less than a threshold.

The display information control unit 126 selects the recommended information whose suitability level is equal to or greater than a threshold as suitable information, and switches a display of recommended information, whose information similarity with suitable information is equal to or less than a threshold, from among recommended information arranged within a certain distance from the suitable information, to a display of new recommended information, which is selected based on the suitable information from a new recommended information group acquired from the recommended information acquisition unit 125 at a point in time when the attention level becomes equal to or less than a threshold, from among the recommended information arranged within the certain distance from the suitable information.

The storage device 124 stores data used by the programs executed by the CPU 122. The storage device 124 stores various types of data, such as display information data 127, user-related data 128, and new recommended information data 129.

The display information data 127, which will be described in detail later, is information related to the recommended information being displayed on the information display terminal 5 obtained from the recommended information control server 3, and includes the position and size of the information display area and the content related to the recommended information. The display information data 127 is data in the same format as the display information data 109.

The user-related data 128 is information regarding the user acquired by the user information control server 2, and includes attribute data 110, line of sight data 111, behavior data 112, interest level data 113, attention level data 114 and suitability level data 115 stored in the storage device 104 of the user information control server 2.

The new recommended information data 129 includes recommended information acquired from the recommended information control server 3 which can be displayed next on the information display terminal 5.

The information display terminal 5 is, for example, at least one of the information display terminal 5a, which is a fixed-type signage device, and the information display terminal 5b, which is a user-wearable virtual space display device. The recommended information arranged in the display area of the information display terminals 5a and 5b is, for example, at least one of a two-dimensional surface and a three-dimensional shape.

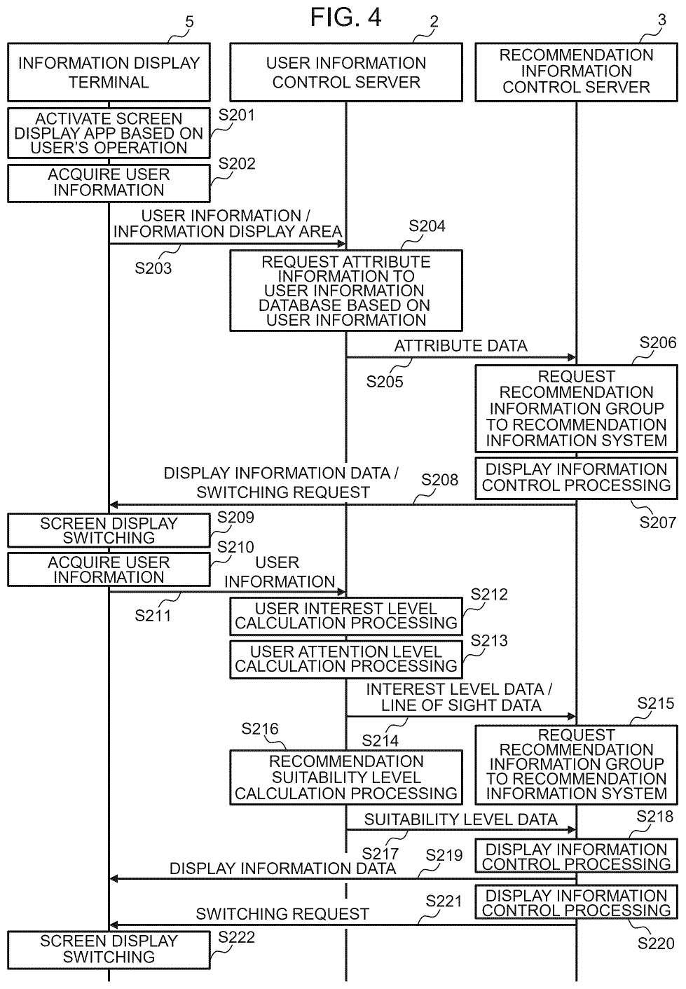

FIG. 4 is a sequence diagram explaining the operation of the information search support system 1. Here, FIG. 4 shows the operations of the information display terminal 5, the user information control server 2, and the recommended information control server 3. The operations of certain illustrated steps will be described in detail later.

Foremost, in response to a user action on the information display terminal 5, for example, the user standing in front of the fixed-type information display terminal 5 or the user wearing the wearable information display terminal 5, a screen display application is launched and information is displayed on the display screen (step S201).

The information display terminal 5 acquires user information using an accompanying input device (step S202). Here, the information display terminal 5 may acquire the user information in coordination with the external input/output device 10. Next, the information display terminal 5 acquires information related to the information display area in which the recommended information is displayed.

The acquired user information and information display area are sent to the user information control server 2, and received by the user information control server 2 (step S203). Here, the information display area is treated as static data, but it may also be treated as dynamic data and sent to the user information control server 2 periodically.

The user information control server 2 stores the received user information as attribute data 110, and stores the received information display area as part of the display information data 109. Next, the user information acquisition unit 105 requests attribute information from the user information database 8 based on information included in the user information, for example, a user ID (step S204). The requested attribute information is sent to the user information control server 2, and is received by the user information control server 2. Upon receiving the necessary information, the user information control server 2 updates the attribute data 110. Furthermore, the user information control server 2 sends the data to the recommended information control server 3 (step S205).

Upon receiving the attribute data 110, the recommended information control server 3 stores it as a part of the user-related data 128.

Next, in the recommended information control server 3, the recommended information acquisition unit 125 requests recommended d information from the information recommendation system 7 based on the user-related data 128 (step S206). The requested recommended information is sent to the recommended information control server 3, and the recommended information control server 3 receives it as new recommended information data 129.

Furthermore, in the recommended information control server 3, as will be described in detail later, the display information control unit 126 calculates the display information data 127 based on the new recommended information data 129 (step S207). Next, the display information data 127 is sent to the information display terminal 5, and at the same time, a request to switch the display screen is sent (step S208).

The information display terminal 5 receives the display information data 127, and updates the display on the display device upon receipt of the display screen switching request (step S209).

The information display terminal 5 acquires user information using an accompanying input device and the external input/output device 10 (step S210). The user information includes the user's line of sight information and behavior information. The acquired user information is sent to the user information control server 2 and is received by the user information control server 2 (step S211).

The user information control server 2 calculates line of sight data 111 and behavior data 112 based on the user's line of sight information and behavior information included in the received user information.

Next, in the user information control server 2, as will be described in detail later, the user interest level calculation unit 106 calculates the user's interest in each piece of recommended information being displayed based on the line of sight data 111 and the behavior data 112, and stores the calculated interest as interest level data 113 (step S212).

In the user information control server 2, as will be described later in detail, the user attention level calculation unit 107 calculates the user's attention level for each piece of recommended information being displayed based on the line of sight data 111 and the behavior data 112, and stores it as attention level data 114 (step S213). In addition, the interest level data 113 is sent to the recommended information control server 3, and the recommended information control server 3 stores it as a part of the user-related data 128 (step S214).

Furthermore, in the recommended information control server 3, the recommended information acquisition unit 125 requests recommended information from the information recommendation system 7 based on the user-related data 128 (step S215). The requested recommended information is sent to the recommended information control server 3, and the recommended information control server 3 receives it as new recommended information data 129.

Next, in the user information control server 2, as will be described in detail later, the recommendation suitability level calculation unit 108 calculates a suitability level as the level to which the user would feel that the display of each piece of recommended information being displayed is appropriate, based on the interest level data 113 and the attention level data 114, and stores it as suitability level data 115 (step S216).

The suitability level data 115 is sent to the recommended information control server 3, and the recommended information control server 3 stores it as a part of the user-related data 128 (step S217).

In the recommended information control server 3, as will be described in detail later, the display information control unit 126 calculates the display information data 127 based on the user-related data 128 and the new recommended information data 129 (step S218). The display information data 127 is sent to the information display terminal 5, and received by the information display terminal 5 (step S219).

In the recommended information control server 3, the display information control unit 126 determines the timing to switch the recommended information based on the line of sight data included in the user-related data 128 (step S220), and sends a request to switch the display screen to the information display terminal 5, which is received by the information display terminal 5 (step S221).

Upon receiving the display screen switching request, the information display terminal 5 updates the display on the display device based on the display information data 127 (step S222). When updating the display, voice information may be presented to the user using a voice output device provided in the information display terminal 5 and the external input/output device 10.

The flow of subsequent steps S210 to S222 may be repeated.

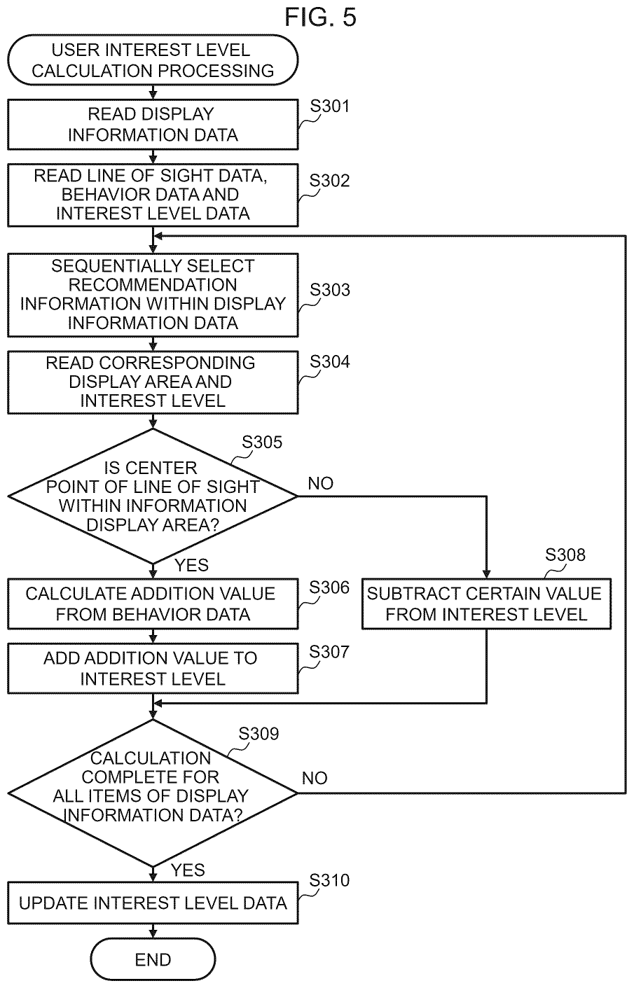

FIG. 5 is a flowchart detailing the processing performed by the user interest level calculation unit 106 of the user information control server 2 in step S212 of FIG. 4.

Foremost, the user interest level calculation unit 106 reads the display information data 109 (step S301). As described above, the display information data 109 is configured from the recommended information from acquired the information recommendation system 7 and an information display area including the display position and size of the recommended information.

Next, the user interest level calculation unit 106 reads the line of sight data 111, the behavior data 112, and the interest level data 113 (step S302). As described above, the line of sight data 111 is information regarding the user's line of sight, such as the direction of the user's line of sight and the duration of the line of sight. As described above, the behavior data 112 is information regarding the user's behavior, such as the user's body posture information, operation information, heart rate, facial expression, and voice information. As described above, the interest level data 113 is information regarding the level to which the user is interested in each piece of recommended information being displayed.

Next, the user interest level calculation unit 106 sequentially selects the recommended information in the display information data 109 (step S303). Next, the user interest level calculation unit 106 reads the information display area and the interest level corresponding to the selected recommended information based on the display information data 109 and the interest level data 113 (step S304). Next, the user interest level calculation unit 106 acquires the line of sight center point from the line of sight data 111, and determines whether or not it is within the read information display area (step S305).

As a result, when the line of sight center point is within the corresponding information display area (“Yes” in step S305), the user interest level calculation unit 106 calculates an addition value to be added to the interest level based on the line of sight data 111 and the behavior data 112 (step S306). Specifically, for example, the addition value can be calculated based on the user's heart rate included in the behavior data 112.

Next, an addition value is added to the corresponding interest level (step S307). If the line of sight center point is not within the corresponding information display area (“No” in step S305), a certain value is subtracted from the corresponding interest level (step S308).

After step S307 and step S308, the user interest level calculation unit 106 determines whether or not the processing has been completed for all recommended information in the display information data (step S309).

As a result, if the processing has not been completed (“No” in step S309), the user interest level calculation unit 106 returns to step S303.

Meanwhile, when the processing has been completed (“Yes” in step S309), the user interest level calculation unit 106 updates the interest level data 113 based on the corresponding interest level (step S310). The user interest level calculation unit 106 thereby ends the user interest calculation processing (step S212 in FIG. 4).

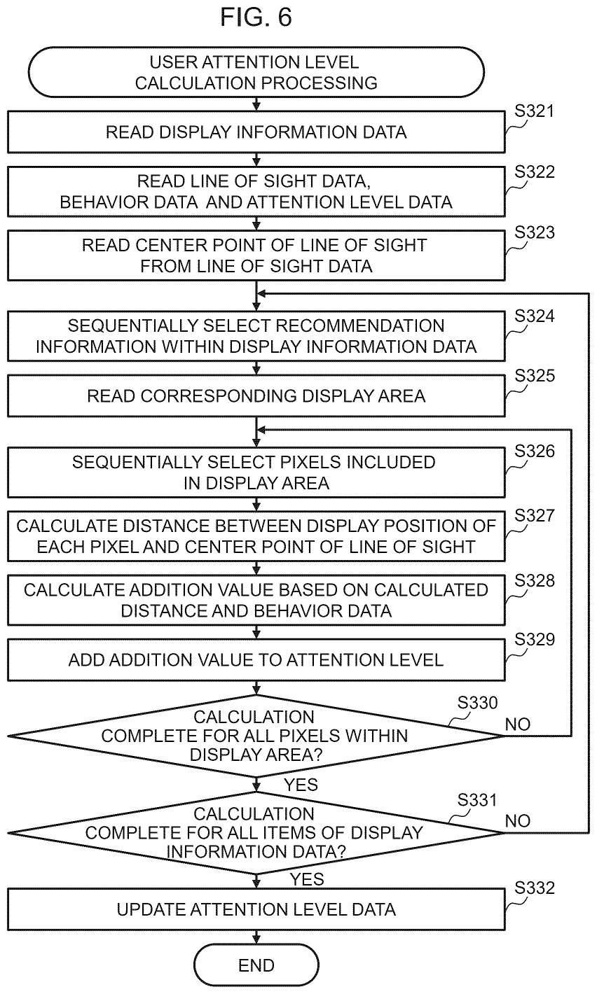

FIG. 6 is a flowchart detailing the processing performed by the user attention level calculation unit 107 of the user information control server 2 in step S213 of FIG. 4.

Foremost, the user attention level calculation unit 107 reads the display information data 109 (step S321). Next, the user attention level calculation unit 107 reads the line of sight data 111, the behavior data 112, and the attention level data 114 (step S322). As described above, the attention level data 114 is information on the level to which the user is paying attention to each piece of recommended information being displayed at a certain point in time.

Next, the user attention level calculation unit 107 reads the line of sight center point based on the line of sight data 111 (step S323).

The user attention level calculation unit 107 sequentially selects the recommended information in the display information data 109 (step S324). The user attention level calculation unit 107 reads the information display area corresponding to the selected recommended information based on the display information data 109 and the interest level data 113 (step S325).

Next, the user attention level calculation unit 107 sequentially selects pixels included in the display area (step S326), and then calculates the distance between the display position of each pixel and the line of sight center point (step S327). Furthermore, the user attention level calculation unit 107 calculates an addition value to be added to the attention level based on the calculated distance and the behavior data 112 (step S328).

Specifically, for example, the user attention level calculation unit 107 can calculate the addition value by calculating a weighting value based on the user's body posture information included in the behavior data 112, using the cosine similarity between a vector representing the user's face direction and a vector representing the line of sight data 111. Note that the attention level may also be calculated using only the distance from the center of the display area.

Next, the addition value is added to the corresponding attention level (step S329). The user attention level calculation unit 107 determines whether or not the processing has been completed for all pixels in the information display area (step S330).

As a result, if the calculation processing has not been completed for all pixels in the display area (“No” in step S330), the user attention level calculation unit 107 returns to step S326.

When the calculation processing has been completed (“Yes” in step S330), the user attention level calculation unit 107 determines whether the processing has been completed for all recommended information in the display information data (step S331).

As a result, if the calculation processing has not been completed for all recommended information of the display information data (“No” in step S331), the user attention level calculation unit 107 returns to step S324. Meanwhile, if the calculation processing has been completed (“Yes” in step S331), the user attention level calculation unit 107 updates the attention level data 114 based on the corresponding attention level (step S332). The user attention level calculation unit 107 thereby ends the user attention level calculation processing (step S213 in FIG. 4).

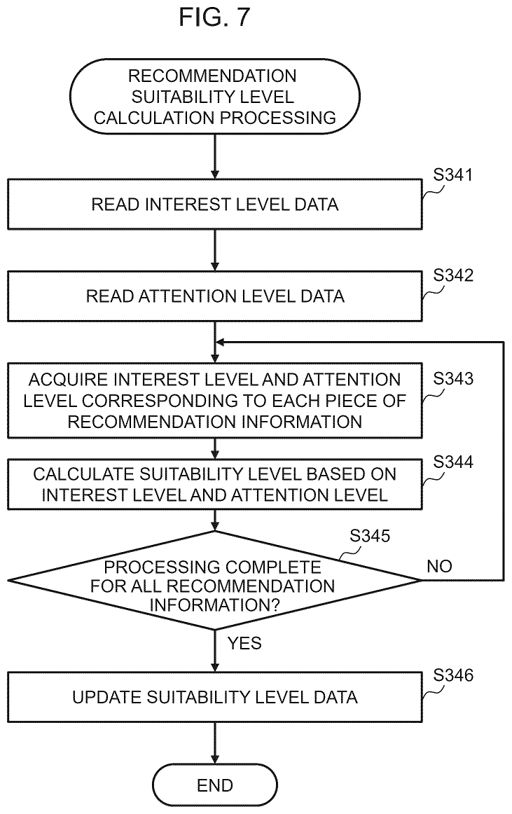

FIG. 7 is a flowchart detailing the processing performed by the recommendation suitability level calculation unit 108 of the user information control server 2 in step S216 of FIG. 4.

Foremost, the recommendation suitability level calculation unit 108 reads the interest level data 113 (step S341). Next, the recommendation suitability level calculation unit 108 reads the attention level data 114 (step S342).

The recommendation suitability level calculation unit 108 sequentially acquires the interest level and attention level corresponding to each piece of recommended information based on the read interest level data 113 and attention level data 114 (step S343).

The recommendation suitability level calculation unit 108 calculates the suitability level from the interest level and attention level corresponding to each piece of recommended information acquired (step S344). As described above, the suitability level is the level to which the user feels that the display of each piece of recommended information being displayed is appropriate. The suitability level z_i can be derived, for example, by the following formula (1) using the interest level x_i and attention level y_i corresponding to a certain piece of recommended information i.

$$z\_ ( i ) = ax\_ ( i ) + bx\_ ( i ) … \qquad ( 1 )$$

Here, the coefficients a and b are constants, and the recommendation suitability level calculation unit 108 can adjust the coefficients based on the user's reaction to the recommendation result. Note that the interest level x_i and the attention level y_i are not limited to scalar values, and may also be vector values.

In addition, the recommendation suitability level calculation unit 108 determines whether the recommendation suitability calculation processing has been completed for all recommended information (step S345). As a result, if the process has not been completed for all recommended information (“No” in step S345), the recommendation suitability level calculation unit 108 returns to step S343.

Meanwhile, if the processing has been completed for all recommended information (“Yes” in step S345), the recommendation preference calculation unit 108 updates the suitability level data (step S346). The recommendation preference calculation unit 108 thereby ends the recommendation suitability level calculation processing (step S214 in FIG. 4).

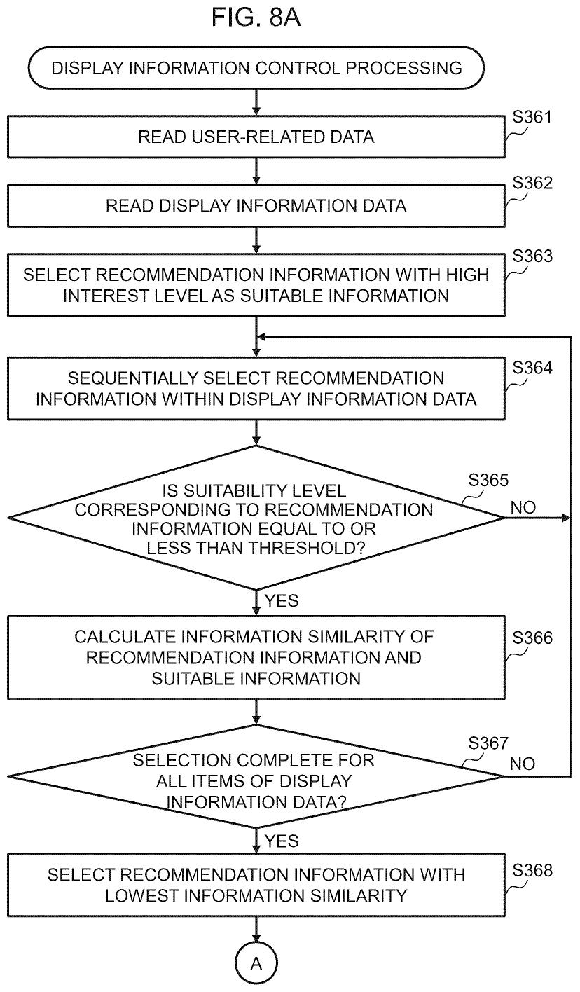

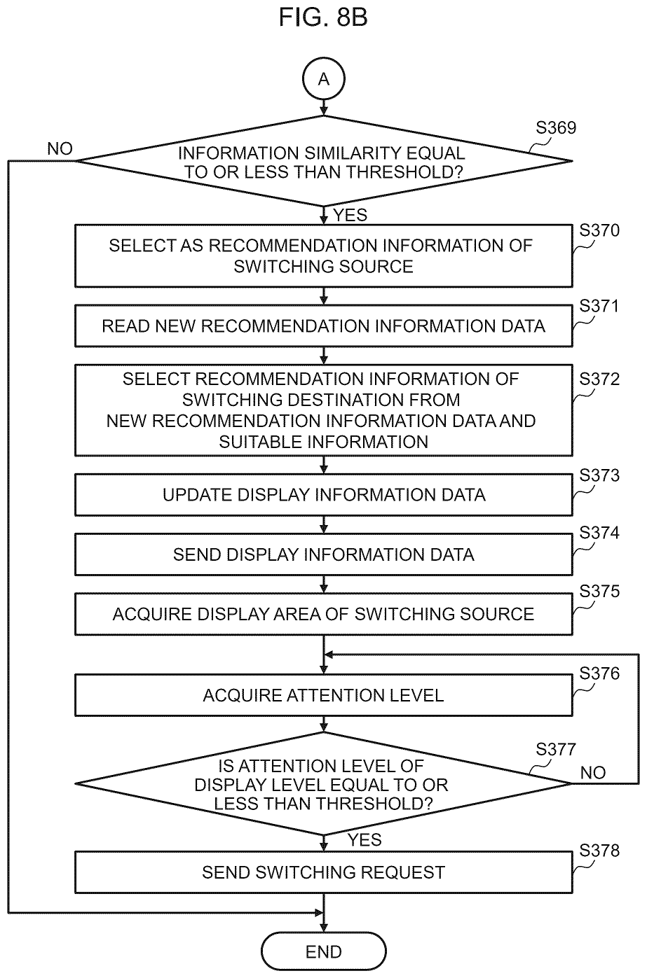

FIGS. 8A and 8B are flowcharts detailing the processing performed by the display information control unit 126 of the recommended information control server 3 in step S218 and step S220 of FIG. 4.

Foremost, the display information control unit 126 reads the user-related data 128 created in step S212, step S213 and step S215 in FIG. 4 (step S361).

Next, the display information control unit 126 reads the display information data 127 (step S362).

Next, the display information control unit 126 selects the recommended information with the highest level of interest as the suitable information based on the interest level included in the user-related data 128 and the recommended information included in the display information data 127 (step S363). Here, the suitable information is selected as a single piece of recommended information, but the suitable information may be composed of a plurality of pieces of recommended information.

Next, the display information control unit 126 sequentially selects the recommended information included in the display information data 127 (step S364). In other words, the display information control unit 126 repeats the subsequent processing until all recommended information included in the display information data 127 has been selected.

The display information control unit 126 acquires the suitability level corresponding to the selected recommended information and determines whether it is below a threshold (step S365). As a result, if the suitability level is below a certain threshold (“Yes” in step S365), the display information control unit 126 calculates the information similarity between the selected recommended information and the suitable information (step S366).

Furthermore, the display information control unit 126 determines whether or not the selection of all recommended information in the display information data has been completed (step S367).

In step S365 and step S367, if the suitability level is not below a certain threshold (“No” in step S365) and if the selection of all recommended information has not been completed (“No” in step S367), the display information control unit 126 returns to step S364.

Meanwhile, if the selection of all recommended information has been completed in step S367 (“Yes” in step S367), the display information control unit 126 selects the recommended information having the lowest information similarity to the suitable information from among the recommended information for which step S366 has been executed so far (step S368), and determines whether the information similarity is below a threshold (step S369).

As a result, if the information similarity is not equal to or less than the threshold (“No” in step S369), the display information control unit 126 ends the processing. Meanwhile, if the information similarity is equal to or less than the threshold (“Yes” in step S369), the display information control unit 126 sets the recommended information selected in step S368 as the recommended information of the switching source (step S370). The display information control unit 126 reads new recommended information data 129 acquired by the recommended information acquisition unit (step S371).

The display information control unit 126 selects the recommended information of the switching destination based on the new recommended information data 129 and the suitable information (step S372). Specifically, for example, the display information control unit 126 may select the recommended information having a high level of information similarity with the suitable information, or may coordinate with the information recommendation system 7 through the recommended information acquisition unit 125 to acquire new recommended information based on the suitable information.

Next, the display information control unit 126 updates the display information data 109 by swapping the recommended information of the switching source with the new recommended information (step S373). Furthermore, the display information control unit 126 sends the updated display information data 109 to the information display terminal 5 (step S374, step S219 in FIG. 4). The display information control unit 126 acquires the display area of the recommended information of the switching source from the display information data 109 (step S375).

Next, the display information control unit 126 acquires the attention level included in the user-related data 128 (step S376). Note that the display information control unit 126 may connect to the user information control server 2 to acquire the latest attention level data 114.

The display information control unit 126 determines whether the attention level corresponding to the display area of the recommended information is equal to or less than the threshold (step S377). As a result, if the attention level is not equal to or less than the threshold (“No” in step S377), the display information control unit 126 returns to step S376. Meanwhile, if the attention level is equal to or less than the threshold, the display information control unit 126 requests the information display terminal 5 to switch the screen display (step S378, step S221 in FIG. 4), and thereby ends the processing.

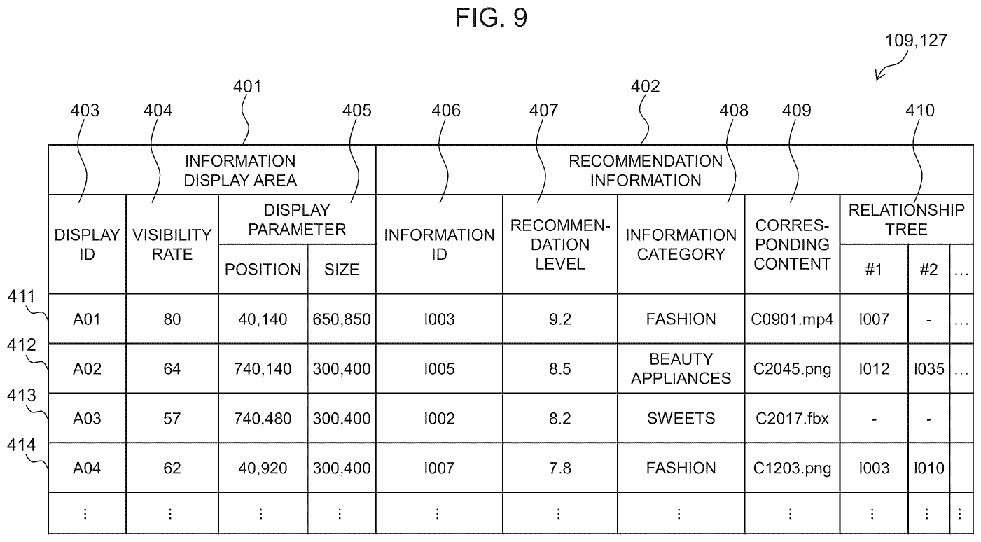

FIG. 9 is a diagram showing the details of the display information data 109/127. The display information data 109/127 shown in FIG. 9 is configured from an information display area 401 and recommended information 402. The information display area 401 includes a display ID 403, a visibility rate 404, and a display parameter 405.

The display ID 403 is an ID assigned to each information display area of the information display terminal 5. Here, the information display terminal 5 has at least four information display areas, and A01, A02, A03, and A04 are set as the display IDs 403 for each of them. Note that the information display areas may dynamically change over time.

The visibility rate 404 is the ease with which the information display area corresponding to each information display area can be seen, and is calculated, for example, using user information acquired by the information display terminal 5, based on the percentage of people whose central point of viewpoint includes the information display area displayed on the information display terminal 5. Note that the visibility rate 404 may use a constant value, or may change in accordance with the change in the information display area.

The display parameter 405 is a parameter related to the information display area corresponding to the display ID 403. Here, the position and size are shown on the assumption that the information display area is arranged on a two-dimensional plane. Note that, when the information display area is arranged in a three-dimensional space, the display parameter 405 may include information related to the posture in addition to the position and size.

The recommended information 402 includes an information ID 406, a recommendation level 407, an information category 408, a corresponding content 409, and a relationship tree 410.

The information ID 406 is an ID assigned to each piece of recommended information acquired by the recommended information acquisition unit 125 of the recommended information control server 3. Here, it is shown that I003, I005, I002, and I007 are set as information IDs 406 for information display areas corresponding to A01, A02, A03, and A04, which are the display IDs 403. Note that the number of information IDs 406 set in an information display area corresponding to a certain display ID 403 may be one or more.

The recommendation level 407 is the level of recommending the recommended information acquired from the information recommendation system 7 via the recommended information control server 3.

The information category 408 is an attribute of the recommended information acquired from the information recommendation system 7 via the recommended information acquisition unit 125. Here, recommended information for general consumers, such as fashion, beauty appliances, and cosmetics, is shown.

The corresponding content 409 is information on the content corresponding to the information ID acquired from the content database 9. Here, the storage location of the file is shown, but it may also be address information (URL) for obtaining the content via the Internet.

The relationship tree 410 is a relationship between recommended information items acquired from the information recommendation system 7 via the recommended information acquisition unit 125. For example, it is an information ID of another piece of recommended information which is frequently viewed by a user who has viewed a certain piece of recommended information.

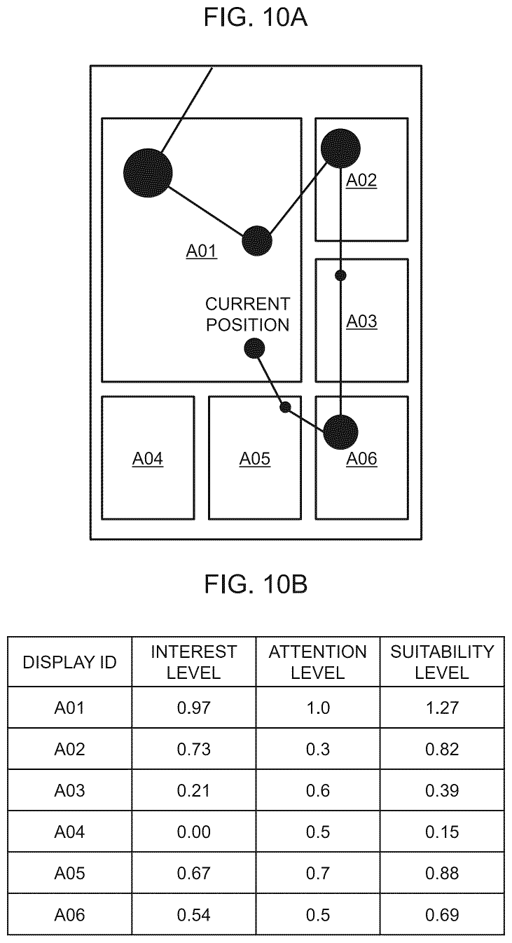

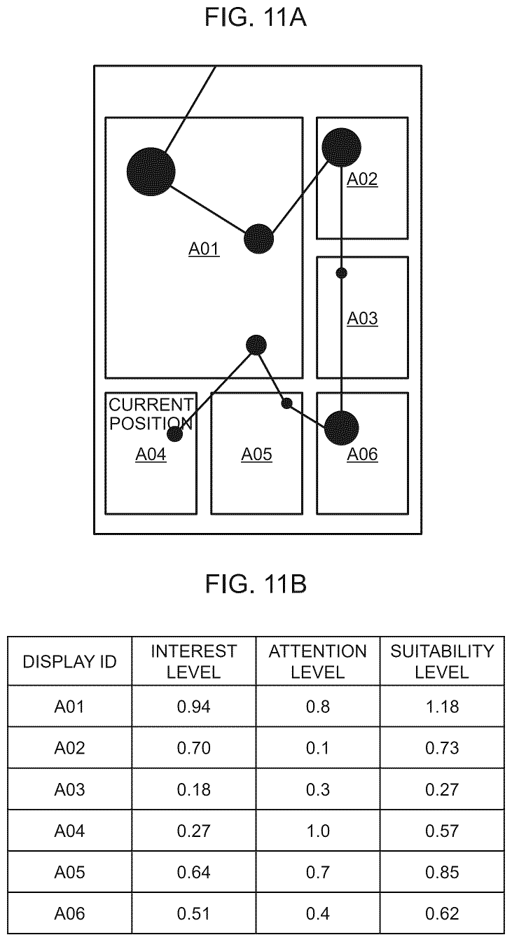

FIG. 10A and FIG. 11A are diagrams each showing a case where recommended information is displayed on the fixed-type information display terminal 5a in step S222 of FIG. 4.

Here, an example is shown in which recommended information having information IDs A01 to A06 is displayed on the information display terminal 5a, fixed-type signage device, based on the display information data illustrated in FIG. 9. Note that, while an example is shown in which an image is displayed as the content of the recommended information, the display target does not have to be limited to this. In other words, the display form of the content corresponding to the recommended information is not limited to image data, and it may be text data, video data, voice data, or a three-dimensional model. There may be one or more pieces of content corresponding to each piece of recommended information, and each may have a different display form.

Here, FIG. 10A shows an example of the arrangement of recommended information, and the movement of line of sight over a certain period of time and the current line of sight position. Here, black circles indicate stationary line of sight points, and the larger the circle, the longer the stationary time. Lines between multiple black circles, or lines entering or exiting black circles, represent line of sight (same in FIG. 11A).

FIG. 10B shows an example of the interest level calculated by the user interest level calculation unit, the attention level calculated by the user attention level calculation unit, and the suitability level calculated by the recommendation suitability level calculation unit in the case of FIG. 10A.

Next, FIG. 11A shows the movement of the line of sight and the current line of sight position when the line of sight of the user moves to A04 immediately after FIG. 10A. FIG. 11B shows an example of the interest level calculated by the user interest level calculation unit, the attention level calculated by the user attention level calculation unit, and the suitability level calculated by the recommendation suitability level calculation unit in the case of FIG. 11A.

In the first embodiment, the display information control unit 126 controls the display information, for example, in the flow shown in FIGS. 8A and 8B. In the case of FIG. 10A and FIG. 10B, if the display information data 109/127 used is the one illustrated in FIG. 9, I003 corresponding to A01 is selected as the suitable information, and then the recommended information whose suitability is below the threshold is set as the recommended information candidate of the switching source.

Next, the threshold of the suitability is set to 0.30, and the information similarity between the recommended information I007 corresponding to A04 and the recommended information I003 corresponding to A01 is calculated. Here, referring to the relationship tree 410, it is assumed that the information similarity between I003 and I007 is high, so I007 corresponding to A04 is not selected as the recommended information of the switching source.

When the state changes to that shown in FIG. 11A and FIG. 11B, I003 corresponding to A01 is selected as the suitable information, and I002 corresponding to A03 is selected as the recommended information candidate of the switching source. Here, I003 and I002 belong to different information categories 408 and are not in a tree relationship, so there is a possibility that the information similarity is low. If the information similarity is low, I002 corresponding to A03 can be selected as the recommended information of the switching source.

According to the first embodiment, the recommended information displayed in a limited display area can be switched based on the user's line of sight and behavior, thereby improving user convenience and information search efficiency. Moreover, according to the first embodiment, by switching information at an appropriate time based on the user's line of sight and behavior, information search can be supported without user operation and without compromising user experience.

### (2) Second Embodiment

Because the information display system including the information search support system according to the second embodiment basically has the same configuration and function as the information display system S including the information search support system 1 according to the first embodiment, the explanation of the similarities will be omitted and the following explanation will focus on the differences.

In the second embodiment, a user is wearing an information display terminal 5b, which is a wearable virtual space display device such as XR goggles, and can access stores and sales areas in the virtual space via the Internet. When the user accesses the virtual space, the information display terminal 5 arranges recommended information in the virtual space based on the user's attributes and behavior information, and displays it on the device. Here, the information search support system 1 and the information display terminal 5 select recommended information which the user is interested in based on the user's line of sight information, and when the user's line of sight is directed around the selected recommended information, display new recommended information around the selected recommended information.

In the second embodiment also, the recommended information suitable for the user can be switched at a suitable timing in the same manner as in the first embodiment. However, unlike the first embodiment, the second embodiment switches information within the user's line of sight. Therefore, the display control method of the display information control unit 126 of the recommended information control server 3 differs between the first embodiment and the second embodiment.

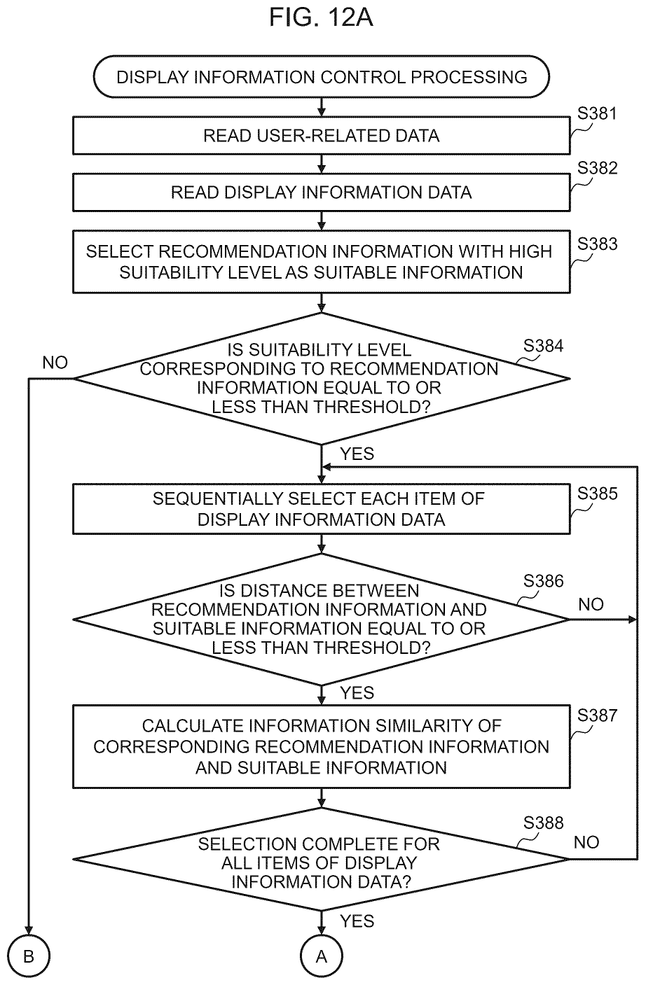

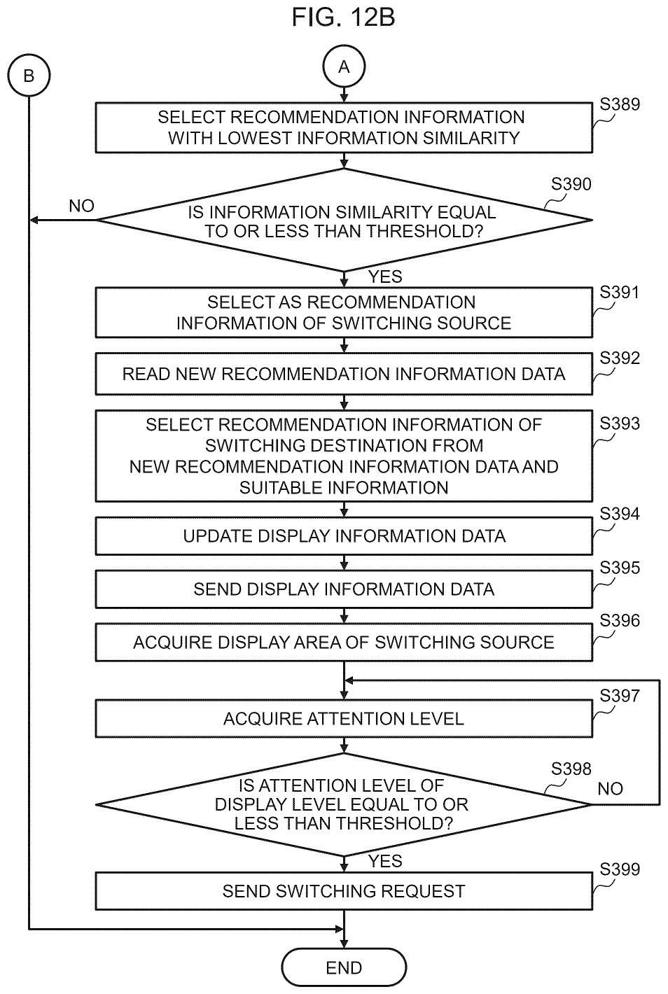

FIGS. 12A and 12B are flowcharts detailing the processing performed by the display information control unit 126 of the recommended information control server 3 in step S218 and step S220 of FIG. 4 in the second embodiment. The flowchart shown in FIG. 12A and 12B in the second embodiment differs from the flowchart shown in FIGS. 8A and 8B in the first embodiment in which it includes steps S384 and S386, which will be described later.

Foremost, the display information control unit 126 reads the user-related data 128 created in step S212, step S213 and step S215 in FIG. 4 (step S381). Next, the display information control unit 126 reads the display information data 127 (step S382).

Next, the display information control unit 126 selects the recommended information with the highest suitability level as the suitable information based on the suitability level included in the user-related data 128 and the recommended information included in the display information data 127 (step S383). Here, the suitable information is selected as a single piece of recommended information, but the suitable information may also be composed of a plurality of pieces of recommended information.

Next, the display information control unit 126 determines whether the suitability level of the selected suitable information is equal to or greater than the threshold (step S384). If the suitability level of the suitable information is less than the threshold (“No” in step S384), the display information control unit 126 ends the processing.

Next, if the suitability level of the suitable information is equal to or greater than the threshold (“Yes” in step S384), the display information control unit 126 sequentially selects each item of the display information data 127 (step S385). In other words, the display information control unit 126 repeats the subsequent processing until all display information data 127 has been selected.

The display information control unit 126 determines whether the display distance between the selected recommended information and the suitable information is below a threshold based on the display area corresponding to the selected recommended information and the display area corresponding to the suitable information (step S386).

As a result, if the display distance is below a certain threshold (“Yes” in step S386), the display information control unit 126 calculates the information similarity between the selected recommended information and suitable information (step S387).

Furthermore, the display information control unit 126 determines whether or not the selection of all recommended information in the display information data has been completed (step S388). In step S386 and step S388, if the display distance is not below a certain threshold (“No” in step S386) and if the selection of all recommended information has not been completed (“No” in step S388), the display information control unit 126 returns to step S385.

Moreover, if the selection of all recommended information has been completed in step S388 (“Yes” in step S388), the display information control unit 126 selects the recommended information having the lowest information similarity to the suitable information from among the recommended information for which step S387 has been executed (step S389), and determines whether the information similarity is equal to or lower than a threshold (step S390). If the information similarity is not equal to or lower than the threshold (“No” in step S390), the display information control unit 126 ends the processing.

If the information similarity is equal to or smaller than the threshold (“Yes” in step S390), the display information control unit 126 sets the recommended information selected in step S389 as the recommended information of the switching source (step S391).

The display information control unit 126 reads the new recommended information data 129 acquired by the recommended information acquisition unit (step S392).

The display information control unit 126 selects the recommended information of the switching destination based on the new recommended information data 129 and the suitable information (step S393). Specifically, for example, the display information control unit 126 may select the recommended information having a high level of information similarity with the suitable information, or coordinate with the information may recommendation system 7 via the recommended information acquisition unit 125 to acquire new recommended information based on the suitable information.

Next, the display information control unit 126 updates the display information data 109 by swapping the recommended information of the switching source with the new recommended information (step S394). Furthermore, the display information control unit 126 sends the updated display information data 109 to the information display terminal 5 (step S395, step S219 in FIG. 4). The display information control unit 126 acquires the display area of the recommended information of the switching source from the display information data 109 (step S396).

Next, the display information control unit 126 acquires the attention level included in the user-related data 128 (step S397). Note that the display information control unit 126 may also connect to the user information control server 2 to acquire the latest attention level data 114.

The display information control unit 126 determines whether the attention level corresponding to the display area of the recommended information is equal to or greater than a threshold (step S398). As a result, if the attention level is below the threshold (“No” in step S398), the display information control unit 126 returns to step S397. Meanwhile, if the attention level is equal to or greater than the threshold, the display information control unit 126 requests the information display terminal 5 to switch the screen display (step S399, step S221 in FIG. 4), and thereby ends the processing.

In the second embodiment, based on the user's line of sight information, new recommended information can be displayed at a timing when the user's line of sight is directed to the vicinity of recommended information in which the user is interested.

### 3. Explanation of Information Search Support Method

The processing described above performed by the information search support system 1 is realized by the coordination of software and hardware resources. In other words, the processor in the computer device provided in the information search support system 1 loads into the memory and executes the software which realizes each of the above-described functions, thereby realizing each of these functions.

Therefore, the processing performed by the information search support system 1 can be considered as an information search support method in which a processor executes software recorded in the memory to obtain user information data on the user's attributes, line of sight information, and behavior information, coordinates with the information recommendation system 7 to obtain display information data on recommended information and information display areas, and displays recommended information suitable for the user at an appropriate timing based on the user information data and display information data.

Moreover, in this embodiment, from the viewpoint of switching the display of information to be given to a user at a timing suitable for the user based on user information data and display information data, it can be regarded as a display control method.

The information display system S according to this embodiment includes at least the information display terminal 5 which displays recommended information, and the following information search support system 1. The information search support system 1 is an information search support system which coordinates with an information recommendation system 7 which provides recommended information to an information display terminal 5 which displays the recommended information to a user, comprising: a user information acquisition unit 105 which acquires user information including line of sight information indicating a line of sight of the user toward the information display terminal 5; a user interest level calculation unit 106 which estimates in real time a user interest level which indicates a level of interest of the user in each piece of recommended information based on user information acquired over a predetermined time period; a user attention level calculation unit 107 which estimates in real time a level of attention which indicates a level to which the user is currently paying attention to each piece of recommended information based on currently acquired user information; a recommendation suitability level calculation unit 108 which calculates a level of suitability for each piece of recommended information based on the interest level and the attention level; a recommended information acquisition unit 125 which acquires a new recommended information group from the information recommendation system based on the user information and the interest level; and a display information control unit 126 which determines a timing of switching to suitable recommended information based on the suitability level, the interest level, and the new recommended information, and requests the information display terminal to switch the recommended information being displayed.

In this way, since no operation by the user is required, the user's convenience is not compromised, and the efficiency of searching for recommended information is improved, while the recommended information which is likely to attract the user's interest can be switched to and displayed.

In this embodiment, the information display terminal 5 is, for example, at least one of the information display terminal 5a which is a fixed-type signage device and the information display terminal 5b which is a user-wearable virtual space display device, and the recommended information arranged in the display area of the information display terminals 5a and 5b is at least one of a two-dimensional surface and a three-dimensional shape. In this way, it is possible to display, for example, on at least one display device of the information display terminal 5a which is a fixed-type signage device and the information display terminal 5b which is a user-wearable virtual space display device so as to switch to recommended information which is likely to attract the user's interest without requiring user operation.

In this embodiment, the user information acquisition unit 105 acquires, as user information, the user's behavior information and the user's attribute information in addition to line of sight information. In this way, it is possible to switch to and display recommended information which is likely to attract the user's interest based on the user behavior information and user attribute information without requiring user operation.

In this embodiment, the line of sight information is acquired by at least one of an eye tracking device built into the information display terminal 5 and a device installed in the external environment, and is projected as a line of sight center point on a line of sight detection surface which takes the form of at least one of a two-dimensional surface and a three-dimensional shape. In this way, it is possible to switch to and display recommended information which is likely to attract the user's interest by projecting it as a line of sight center point on a line of sight detection surface which takes the form of at least one of a two-dimensional surface and a three-dimensional shape, without requiring user operation.

In this embodiment, the behavior information includes, for example, at least one of the user's posture information, operation information, heart rate, facial expression, and voice information, and is acquired by at least one of the device installed in the information display terminal 5 and the device worn by the user. In this way, at least one of the user's posture information, operation information, rate, heart facial expression, and voice information is acquired by at least one of the device installed in the information display terminal 5 and the device worn by the user, so that it is possible to switch to and display recommended information which is likely to attract the user's interest, without requiring user operation, based on the behavior information including at least one of the user's posture information, operation information, heart rate, facial expression, and voice information.

In this embodiment, the attribute information includes, for example, at least one of the user's age, gender, preference information, online purchase history and browsing history, and is acquired from a device held by the user or an external server device (not shown) in which the user's attribute information is registered. In this way, since the attribute information is acquired from a device held by the user or an external server device (not shown) in which the user's attribute information is registered, it is possible to switch to and display recommended information which is likely to attract the user's interest, without requiring user operation, based on the attribute information including at least one of the user's age, gender, preference information, online purchase history and browsing history.

In this embodiment, the user interest level calculation unit 106 uses the line of sight information to add a value to each piece of recommended information when the line of sight center point is included in the display area of the recommended information, and the accumulated value for a certain period of time is taken as the interest level for each piece of recommended information. In this way, it is possible to switch to and display recommended information which is more likely to attract the user's interest based on the accumulated value for a certain period of time and the interest level for each piece of recommended information, without requiring user operation.

In this embodiment, the user attention level calculation unit 107 sets a value calculated based on the distance between the current line of sight center point obtained by using the line of sight information and the display area of the recommended information as the attention level for each piece of recommended information. In this way, without requiring user operation, it is possible to switch to and display recommended information which is likely to attract the user's interest based on the attention level for each piece of recommended information, which is calculated based on the distance between the current line of sight center point and the display area of the recommended information.

In this embodiment, the user interest level calculation unit 106 uses the line of sight information to subtract the interest level for each piece of recommended information when the line of sight center point is not included in the display area of the recommended information. In this way, it is possible to switch to and display recommended information which is more likely to attract the user's interest without requiring user operation.

In this embodiment, the user interest level calculation unit 106 adjusts the size of the addition value and the subtraction value by using the line of sight information, the behavior information, and the attention level. In this way, it is possible to switch to and display recommended information which is more likely to attract the user's interest without requiring user operation.

In this embodiment, the display information control unit 126 selects recommended information with a high level of interest as suitable information, calculates information similarity between the suitable information and recommended information with a suitability level equal to or lower than a threshold, and switches the display of recommended information with information similarity equal to or lower than the threshold to display of new recommended information selected based on the suitable information from a new recommended information group acquired from the recommended information acquisition unit 125 at a point in time when the attention level becomes equal to or less than the threshold. In this way, it is possible to switch to and display recommended information which is more likely to attract the user's interest according to the level of attention without requiring user operation.

In this embodiment, the display information control unit 126 selects recommended information whose suitability is equal to or greater than a threshold as suitable information, calculates information similarity between the suitable information and new recommended information acquired from the recommended information acquisition unit 125, and switches the display of the suitable information to a display of new recommended information selected based on the suitable information from the new recommended information group acquired from the recommended information acquisition unit 125 at a point in time when the attention level becomes equal to or less than the threshold. In this way, it is possible to switch to and display recommended information which is more likely to attract the user's interest according to the attention level without requiring user operation.

In this embodiment, the display information control unit 126 selects recommended information whose suitability is equal to or greater than a threshold as suitable information, and switches the display of recommended information, whose information similarity with the suitable information is equal to or less than a threshold, from among recommended information arranged within a certain distance from the suitable information, to new recommended information selected based on the suitable information from a new recommended information group acquired from the recommended information acquisition unit 125, at a point in time when the attention level becomes equal to or less than the threshold. In this way, it is possible to switch to and display recommended information which is more likely to attract the user's interest according to the attention level, without requiring user operation.

The present invention is not limited to the embodiments described above, and includes various modified examples and equivalent configurations within the spirit of the appended claims. For example, the foregoing embodiments have been described in detail to clearly explain the present invention, and the present invention is not necessarily limited to those having all of the described configurations. In addition, each element described in parallel in this embodiment may be in a form in which at least one of the elements is connected in series to the other elements.

### INDUSTRIAL APPLICATION

The present invention can be suitably applied to an information search support system, an information search support method, and an information display system related to, for example, a technique for optimally searching for recommended information ideal for a user by using the user's behavior information.

### REFERENCE SIGNS LIST

1 . . . information search support system, 2 . . . user information control server, 3 . . . recommended information control server, 4 . . . communication control unit, 5 . . . information display server, 5a . . . signage device, 5b . . . virtual space display device, 6 . . . network, 7 . . . information recommendation system, 8 . . . user information database, 9 . . . content database, 10 . . . external input/output device, 101, 121 . . . communication I/F, 102, 122 . . . CPU, 103, 123 . . . memory, 104, 124 . . . storage device, 105 . . . user information acquisition unit, 106 . . . user interest level calculation unit, 107 . . . user attention level calculation unit, 108 . . . recommendation suitability level calculation unit, 109, 127 . . . display information data, 110 . . . attribute data, 111 . . . line of sight data, 112 . . . behavior data, 113 . . . interest level data, 114 . . . attention level data, 115 . . . suitability level data, 125 . . . recommended information acquisition unit, 126 . . . display information control unit, 128 . . . user-related data, 129 . . . new recommended information data, S . . . information display system

What is claimed is:

1. An information search support system which coordinates with an information recommendation system which provides recommended information to an information display terminal which displays the recommended information to a user, comprising:
a user information acquisition unit which acquires user information including line of sight information indicating a line of sight of the user toward the information display terminal;
a user interest level calculation unit which estimates in real time a user interest level which indicates a level of interest of the user in each piece of recommended information based on user information acquired over a predetermined time period;
a user attention level calculation unit which estimates in real time a level of attention which indicates a level to which the user is currently paying attention to each piece of recommended information based on currently acquired user information;
a recommendation suitability level calculation unit which calculates a level of suitability for each piece of recommended information based on the interest level and the attention level;
a recommended information acquisition unit which acquires new recommended information from the information recommendation system based on the user information and the interest level; and
a display information control unit which determines a timing of switching to suitable recommended information based on the suitability level, the interest level, and the new recommended information, and requests the information display terminal to switch the recommended information being displayed.

2. The information search support system according to claim 1, wherein:
the information display terminal is at least one of a fixed-type display device and a user-wearable display device; and
the recommended information arranged in a display area of the display device is at least one of a two-dimensional surface and a three-dimensional shape.

3. The information search support system according to claim 2, wherein:
the user information acquisition unit acquires, as the user information, behavior information of the user and attribute information of the user in addition to the line of sight information.

4. The information search support system according to claim 3, wherein:
the line of sight information is acquired by at least one of an eye tracking device built into the information display terminal and a device installed in an external environment, and is projected as a line of sight center point onto a line of sight detection surface which adopts at least one of a two-dimensional surface and a three-dimensional shape.

5. The information search support system according to claim 4, wherein:
the behavior information includes at least one of posture information, operation heart information, rate, facial expression, and voice information of the user; and is acquired by at least one of the display device, a device installed in an external environment, and a device worn by the user.

6. The information search support system according to claim 5, wherein:
the attribute information includes at least one of age, gender, preference information, online purchase history and browsing history of the user; and is acquired by at least one of a device unit held by the user or an external server device in which the user's attribute information is registered.

7. The information search support system according to claim 6, wherein:
the user interest level calculation unit uses, if the line of sight center point is included in a display area of recommended information, the line of sight information and adds a value to each piece of recommended information, and uses a cumulative value over a certain period of time as the interest level in each piece of recommended information.

8. The information search support system according to claim 7, wherein:
the user attention level calculation unit uses a value calculated based on a distance between a current line of sight center point obtained by using the line of sight information and a display area of recommended information as the attention level in each piece of recommended information.

9. The information search support system according to claim 7, wherein:
the user interest level calculation unit uses if the line of sight center point is not included in a display area of recommended information, the line of sight information and subtracts the interest level to each piece of recommended information.

10. The information search support system according to claim 9, wherein:
the user interest level calculation unit adjusts a size of an addition value and a subtraction value by using the line of sight information, the behavior information and the attention level.

11. The information search support system according to claim 2, wherein:
the display information control unit selects the recommended information with a high level of interest as suitable information, calculates an information similarity between the suitable information and the recommended information whose suitability level is equal to or less than a threshold, and switches a display of recommended information whose information similarity is equal to or less than the threshold to a display of new recommended information selected based on the suitable information from a new recommended information group acquired from the recommended information acquisition unit at a point in time when the attention level becomes equal to or less than the threshold.

12. The information search support system according to claim 2, wherein:
the display information control unit selects the recommended information whose suitability level is equal to or greater than a threshold as suitable information, calculates an information similarity between the suitable information and new recommended information acquired from a recommended information acquisition unit, and switches a display of the suitable information to a display of new recommended information selected based on the suitable information from a new recommended information group acquired from the recommended information acquisition unit at a point in time when the attention level becomes equal to or less than the threshold.

13. The information search support system according to claim 12, wherein:
the display information control unit selects the recommended information whose suitability level is equal to or greater than a threshold as suitable information, and switches a display of recommended information, whose information similarity with suitable information is equal to or less than the threshold, from among the recommended information arranged within the certain distance from the suitable information, to a display of new recommended information selected based on the suitable information from a new recommended information group acquired from the recommended information acquisition unit at a point in time when the attention level becomes equal to or less than the threshold.

14. An information search support method based on an information search support system which coordinates with an information recommendation system which provides recommended information to an information display terminal which displays the recommended information to a user, comprising:
a user information acquisition step of a user information acquisition unit acquiring user information including line of sight information indicating a line of sight of the user toward the information display terminal;
a user interest level calculation step of a user interest level calculation unit estimating in real time a user interest level which indicates a level of interest of the user in each piece of recommended information based on user information acquired over a predetermined time period;
a user attention level calculation step of a user attention level calculation unit estimating in real time a level of attention which indicates a level to which the user is currently paying attention to each piece of recommended information based on currently acquired user information;
a recommendation suitability level calculation step of a recommendation suitability level calculation unit calculating a level of suitability for each piece of recommended information based on the interest level and the attention level;
a recommended information acquisition step of a recommended information acquisition unit acquiring new recommended information from the information recommendation system based on the user information and the interest level; and
a display information control step of a display information control unit determining a timing of switching to suitable recommended information based on the suitability level, the interest level, and the new recommended information, and requesting the information display terminal to switch the recommended information being displayed.

15. An information display system based on an information search support system which coordinates with an information recommendation system which provides recommended information to an information display terminal which displays the recommended information to a user, comprising:
a user information acquisition unit which acquires user information including line of sight information indicating a line of sight of the user toward the information display terminal;
a user interest level calculation unit which estimates in real time a user interest level which indicates a level of interest of the user in each piece of recommended information based on user information acquired over a predetermined time period;
a user attention level calculation unit which estimates in real time a level of attention which indicates a level to which the user is currently paying attention to each piece of recommended information based on currently acquired user information;
a recommendation suitability level calculation unit which calculates a level of suitability for each piece of recommended information based on the interest level and the attention level;
a recommended information acquisition unit which acquires new recommended information from the information recommendation system based on the user information and the interest level;
a display information control unit which determines a timing of switching to suitable recommended information based on the suitability level, the interest level, and the new recommended information, and requests the information display terminal to switch the recommended information being displayed; and
an information display terminal which displays the recommended information.
